(19) United States
(12) Patent Application Publication
(10) Pub. No.: US 2025/0305770 A1
(43) Pub. Date: Oct. 2, 2025

(54) DRYING CONTROL SYSTEM AND METHOD BASED ON ELECTRODE PLATE DRYING STATUS MONITORING

(71) Applicant: SAMSUNG SDI CO., LTD., Gyeonggi-do (KR)

(72) Inventors: Jinuk HONG, Gyeonggi-do (KR); Jongdae KIM, Gyeonggi-do (KR)

(73) Assignee: SAMSUNG SDI CO., LTD., Gyeonggi-do (KR)

(21) Appl. No.: 18/909,671

(22) Filed: Oct. 8, 2024

(30) Foreign Application Priority Data
Mar. 29, 2024 (KR) 10-2024-0043009

(51) Int. Cl. F26B 25/22; H01M 10/04

(52) U.S. Cl. CPC F26B 25/22; H01M 10/04

(57) ABSTRACT

Example embodiments disclosed herein include a control system that determines a control condition for electrode plate drying by monitoring a drying status of an electrode plate for a secondary battery, and a method thereof. Examples embodiments include a drying control system based on electrode plate drying status monitoring, including an ultrasonic sensor disposed in a preset area of a secondary battery electrode plate drying furnace, and a drying furnace controller configured to monitor a drying state of an electrode plate using a signal acquired from the ultrasonic sensor, and configured to generate and transmit a drying heat amount control signal according to a result of the monitoring.

### CROSS-REFERENCE TO RELATED APPLICATION

The present application claims the benefit of priority to Korean Patent Application No. 10-2024-0043009, filed on Mar. 29, 2024, in the Korean Intellectual Property Office, the entire disclosure of which is incorporated by reference herein.

### BACKGROUND

### 1. Technical Field

Example embodiments of the present disclosure relate to a control system and a method thereof, and more particularly, to a control system that determines a control condition for electrode plate drying by monitoring a drying status of an electrode plate for a secondary battery, and a method thereof.

### 2. Related Art

When coating and drying an electrode plate for a secondary battery, an X-ray type density meter is typically installed at the rear of a drying furnace, and the density of an electrode plate active material is measured to determine whether the coating is dry. The drying status of the electrode plate is typically not known until the electrode plate reaches the density meter installed at the rear of the drying furnace, and loss of many electrode plates may occur until the drying conditions of the electrode plate are optimized.

### SUMMARY

Accordingly, an examples of the present disclosure include a drying control system and method capable of monitoring the drying status of an electrode plate by using an ultrasonic sensor provided for each drying furnace area during a secondary battery manufacturing process, and performing feedback control on the drying temperature based on monitoring results.

The technical problems to be solved by the present disclosure are not limited to the above-mentioned problems, and other problems not mentioned can be clearly understood by those skilled in the art from the description of the disclosure described below.

In an example embodiment, a drying control system based on electrode plate drying status monitoring includes an ultrasonic sensor located in a preset area of a secondary battery electrode plate drying furnace; and a drying furnace controller that monitors a drying state of an electrode plate using a signal acquired from the ultrasonic sensor, and that generates and transmits a drying heat amount control signal according to a result of the monitoring.

The ultrasonic sensor is located in the preset area of at least one of an electrode plate surface solvent evaporation section, an electrode plate shrinkage section, a solvent evaporation section within electrode plate pores, and an electrode plate drying completion section.

When the ultrasonic sensor is disposed in the electrode plate surface solvent evaporation section, as a reflection signal above a preset standard is sensed by a surface solvent, the drying furnace controller monitors whether an ultrasonic transmission signal is maintained below a desired standard.

When the ultrasonic sensor is disposed in the electrode plate shrinkage section, the drying furnace controller monitors whether an ultrasonic transmission signal increases above a preset slope due to a decrease in a thickness of the electrode plate.

When the ultrasonic sensor is disposed in the solvent evaporation section within electrode plate pores, the drying furnace controller monitors whether an ultrasonic transmission signal is reduced above a preset slope due to a decrease in density caused by an increase in a formation of electrode plate pores.

When the ultrasonic sensor is disposed in the electrode plate drying completion section, the drying furnace controller monitors whether a density change is maintained within a preset range.

In another example embodiment, a drying control method based on electrode plate drying status monitoring includes (a) disposing an ultrasonic sensor in an electrode plate drying furnace; and (b) monitoring a drying status of an electrode plate based on ultrasonic transmission/reception information acquired using the ultrasonic sensor.

In operation (a), the ultrasonic sensor is disposed in at least one of an electrode plate surface solvent evaporation section, an electrode plate shrinkage section, a solvent evaporation section within electrode plate pores, and an electrode plate drying completion section.

When the ultrasonic sensor is disposed in the electrode plate surface solvent evaporation section, operation (b) is performed to monitor whether an intensity of an ultrasonic transmission signal is maintained below a certain standard as a surface solvent causes ultrasonic reflection above a preset standard.

When the ultrasonic sensor is disposed in the electrode plate shrinkage section, operation (b) is performed to monitor whether an intensity of an ultrasonic transmission signal increases above a preset slope as a thickness of the electrode plate decreases.

When the ultrasonic sensor is disposed in the solvent evaporation section within electrode plate pores, operation (b) is performed to monitor whether an intensity of an ultrasonic transmission signal is reduced above a preset slope due to a decrease in density caused by an increase in a formation of electrode plate pores.

When the ultrasonic sensor is disposed in the electrode plate drying completion section, operation (b) is performed to monitor whether an intensity of an ultrasonic transmission signal is maintained within a preset range.

The drying control method based on electrode plate drying status monitoring according to examples of the present disclosure may further include (c) generating an electrode plate drying heat amount control signal based on a result of the monitoring.

### BRIEF DESCRIPTION OF THE DRAWINGS

The following drawings illustrate example embodiments of the present disclosure, and further describe example aspects of the present disclosure together with the detailed description of the present disclosure. Thus, the present disclosure should not be construed as being limited to the drawings:

FIG. 1 schematically illustrates an electrode assembly of a secondary battery;

FIG. 2 schematically illustrates a configuration of a pouch-type secondary battery;

FIG. 3 illustrates a schematic external appearance configuration of a prismatic secondary battery;

FIG. 4 is a cross-sectional view of a cylindrical secondary battery;

FIG. 5 illustrates a drying control system based on electrode plate drying status monitoring according to an example embodiment of the present disclosure;

FIG. 6 illustrates a configuration of an ultrasonic transmitter/receiver and a personal computer (PC), according to an example embodiment of the present disclosure;

FIG. 7 illustrates an electrode plate drying status monitoring process, according to an example embodiment of the present disclosure;

FIG. 8 illustrates a drying control method based on electrode plate drying status monitoring, according to an example embodiment of the present disclosure;

FIG. 9 is a block diagram illustrating a computer

system for implementing a method according to an example embodiment of the present disclosure;

FIG. 10 is an example view of a secondary battery module in which secondary batteries manufactured according to examples of the present disclosure are arranged;

FIG. 11 is an example view of a secondary battery pack including the secondary battery module illustrated in FIG. 10; and

FIG. 12 is a conceptual view of a vehicle including the secondary battery pack illustrated in FIG. 11.

### DETAILED DESCRIPTION

Hereinafter, example embodiments of the present disclosure will be described, in detail, with reference to the accompanying drawings. The terms or words used in the present specification and claims are not to be limitedly interpreted based on their general or ordinary meaning, and should be interpreted as meanings and concepts that are consistent with the technical idea of the present disclosure on the basis of the principle that an inventor can be their own lexicographer to appropriately define concepts of terms to describe their invention in the best way.

The example embodiments described in this specification and the configurations shown in the drawings are only some example embodiments of the present disclosure and do not represent all of the aspects of the present disclosure. Accordingly, it should be understood that there may be various equivalents and modifications that can replace or modify one or more example embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges is within the scope of this invention.

References to two compared elements, features, etc. As being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

The terminology used herein is for the purpose of describing example embodiments of the present disclosure and is not intended to limit the present disclosure.

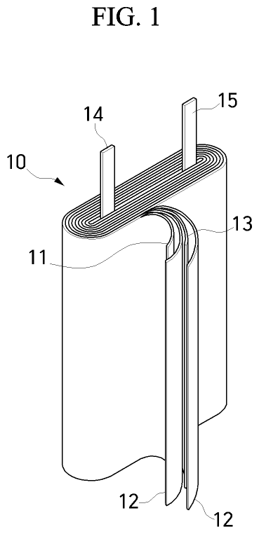

FIG. 1 schematically illustrates an electrode assembly built in a case of a secondary battery.

An electrode assembly 10 may be formed by winding or stacking a stack of a first electrode plate 11, a separator 12, and a second electrode plate 13, which are formed as thin plates or films. When the electrode assembly 10 is a wound stack, a winding axis may be parallel to the longitudinal direction (e.g., the y direction) of the case 59. In other example embodiments, the electrode assembly 10 may be a stack type rather than a winding type, and the shape of the electrode assembly 10 is not limited in the examples of the present disclosure. In addition, the electrode assembly 10 may be or include a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the examples of the present disclosure. The first electrode plate 11 of the electrode assembly may act as a negative electrode, and the second electrode plate 13 may act as a positive electrode. In examples, the reverse is also possible.

The first electrode plate 11 may be formed by applying a first electrode active material, such as graphite or carbon, to a first electrode current collector formed of a metal foil, such as copper, a copper alloy, nickel, or a nickel alloy. The first electrode tab 14 may be connected to an external first terminal (not shown). In some example embodiments, when the first electrode plate 11 is manufactured, the first electrode tab 14 may be formed by being cut in advance to protrude to one side of the electrode assembly 10, or the first electrode tab 14 may protrude to one side of the electrode assembly 10 more than, e.g., farther than or beyond, the separator 12 without being separately cut.

The second electrode plate 13 may be formed by applying a second electrode active material, such as a transition metal oxide, on a second electrode current collector formed of or including a metal foil, such as aluminum or an aluminum alloy. The second electrode plate 13 may include a second electrode tab 15 (e.g., a second uncoated portion) that is or includes a region to which the second electrode active material is not applied. The second electrode tab 15 may be connected to an external second terminal (not shown). In some example embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than, e.g., farther than or beyond, the separator 12 without being separately cut.

In some example embodiments, the first electrode tab 14 may be located on the left side of the electrode assembly 10, and the second electrode tab 15 may be located on the right side of the electrode assembly 10. In other example embodiments, the first electrode tab 14 and the second electrode tab 15 may be located on one side of the electrode assembly 10 in the same direction.

Here, for convenience of description, the left and right sides are defined according to the electrode assembly 10 as oriented in FIG. 1, and the positions thereof may change when the secondary battery is rotated left and right or up and down.

The separator 12 hinders or substantially prevents a short-circuit between the first electrode 11 and the second electrode 13 while allowing movement of lithium ions therebetween. The separator 12 may be made of or include, for example, a polyethylene film, a polypropylene film, a polyethylene-polypropylene film, etc.

In some example embodiments, the electrode assembly 10 may be accommodated in the case (not shown) along with an electrolyte. In the case of a pouch-type secondary battery, an electrode assembly 10 may be accommodated in a pouch made of or including flexible material in the form illustrated in FIG. 1. In the case of a prismatic secondary battery, an electrode assembly 10 may be accommodated in a prismatic metal casing in the form illustrated in FIG. 1.

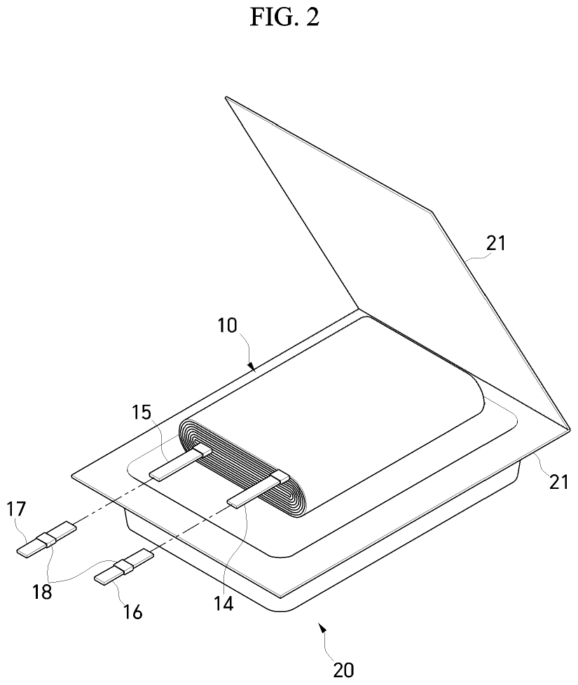

FIG. 2 schematically illustrates the pouch-type secondary battery.

The pouch-type secondary battery includes an electrode assembly 10 and a pouch 20 that accommodates or contains the electrode assembly 10 therein.

The electrode assembly 10 may be the same as the electrode assembly 10 illustrated in FIG. 1. The first electrode tab 14 and the second electrode tab 15 of the electrode assembly 10 may be electrically connected to respective external first and second terminal leads 16 and 17 by, e.g., welding or other attaching method that preserves conductivity therebetween. At least a portion of each of the first terminal lead 16 and the second terminal lead 17 may be attached or covered with a tab film 18 for insulation from the pouch 20.

The pouch 20 may be sealed by having sealing parts 21 at the edges thereof come into contact with each other while accommodating or containing the electrode assembly 10 therein, in which case the sealing may be achieved with the tab film 18 interposed between the sealing parts 21. The sealing parts 21 of the pouch 20 may be made of or include a thermal fusion material that generally has weak adhesion to metal. Thus, it may be fused to the pouch 20 by interposing the thin tab film 18 between the sealing parts 21.

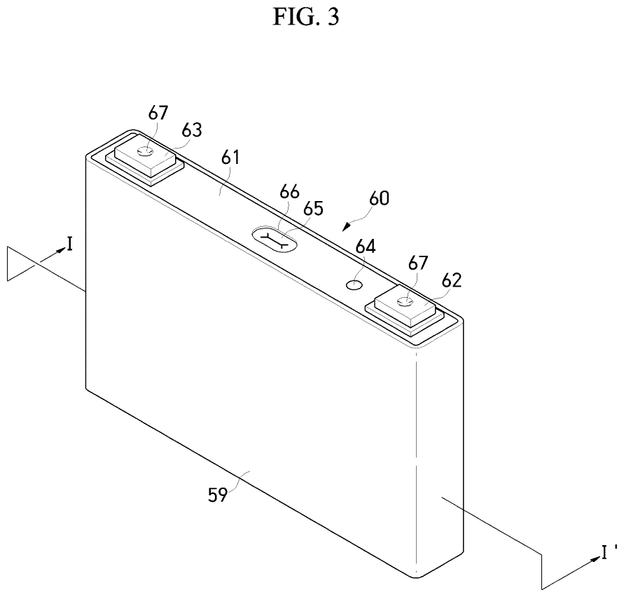

FIG. 3 illustrates a schematic external appearance configuration of a prismatic secondary battery.

A prismatic case 59 defines an overall appearance of the prismatic secondary battery, and may be made of or include a conductive metal, such as aluminum, aluminum alloy, or nickel-plated steel. In addition, the case 59 may provide a space for accommodating or containing the electrode assembly 10 therein.

A cap assembly 60 may include a cap plate 61 that covers an opening of the case 59, and the case 59 and the cap plate 61 may be made of or include a conductive material. A first terminal 63 and a second terminal 62 may be electrically connected to the first electrode tab 14 and the second electrode tab 15 of the electrode assembly 10 illustrated in FIGS. 1 and 2 inside the case 59, and may be installed to protrude outward through the cap plate 61.

The cap plate 61 may be equipped with or include an electrolyte injection port 64 configured to install a sealing plug therein, and a vent 66 formed that includes a notch 65 may be installed. The vent 66 is configured to discharge any gas generated inside the secondary battery.

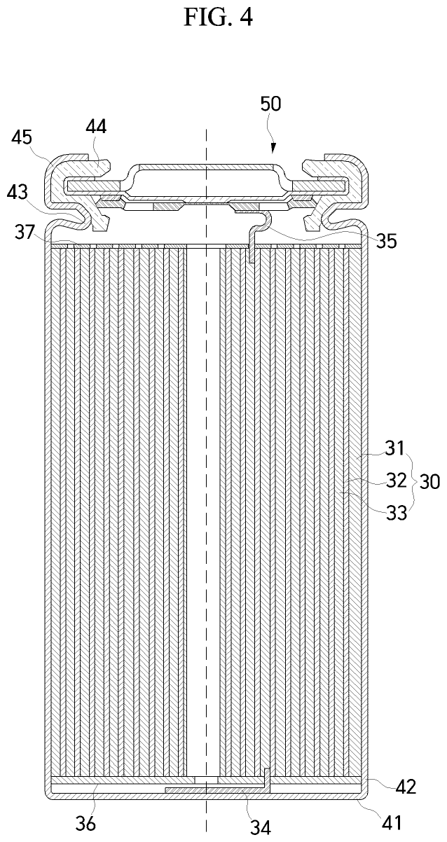

FIG. 4 is a cross-sectional view of a cylindrical secondary battery.

The cylindrical secondary battery includes an electrode assembly 30, a case accommodating the electrode assembly 30 and an electrolyte therein, a cap assembly 50 coupled to an opening of the case to seal the case, and an insulating plate 37 located between the electrode assembly 30 and the cap assembly 50 inside the case.

The electrode assembly 30 may include a separator 32 between a first electrode 33 and a second electrode 31, and the electrode assembly 30 may be wound in a jelly-roll form.

The first electrode 33 may include a first substrate and a first active material layer located on the first substrate. A first lead tab 35 may extend outward from a first uncoated portion of the first substrate where the first active material layer is not located, and may be electrically connected to the cap assembly 50.

The second electrode 31 may include a second substrate and a second active material layer located on the second substrate. A second lead tab 34 may extend outward from a second uncoated portion of the second substrate where the second active material layer is not located, and may be electrically connected to the case. The first lead tab 35 and the second lead tab 34 may extend in opposite directions with respect to each other.

The first electrode 33 may constitute a positive electrode. In this case, the first substrate may be composed of or include, for example, aluminum foil, and the first active material layer may include, for example, a transition metal oxide. The second electrode 31 may constitute a negative electrode. In this case, the second substrate may be composed of or include, for example, copper foil or nickel foil, and the second active material layer may include, for example, graphite.

The separator 32 may reduce or prevent a short-circuit between the first electrode 33 and the second electrode 31 while allowing movement of lithium ions therebetween. The separator 32 may be made of or include, for example, at least one of a polyethylene film, a polypropylene film, a polyethylene-polypropylene film, etc.

The case accommodates or contains the electrode assembly 30 and the electrolyte, and substantially forms the external appearance of the secondary battery together with the cap assembly 50. The case may have a substantially cylindrical body portion 42, and a bottom portion 41 connected to one side of the body portion 42. A beading part 43 deformed inwardly may be formed in the body portion 42, and a crimping part 45 bent inwardly may be formed at an open end of the body portion 42.

The beading part 43 may reduce or prevent movement of the electrode assembly 30 inside the case, and may facilitate seating of a gasket 44 and the cap assembly 50. A crimping part 45 may firmly fix the cap assembly 50 by pressing the edge of the cap assembly 50 against the gasket 44. The case may be formed of or include iron plated with nickel, for example.

The cap assembly 50 may be fixed to the inside of the crimping part 45 through the gasket 44 to seal the case. The cap assembly 50 may include a cap up, a safety vent, a cap down, an insulating member, and a subplate, but is not limited to this example and may be variously modified.

The cap up may be located at the very top of the cap assembly 50. The cap up may include a terminal portion that protrudes convexly upward and is connected to an external circuit, and an outlet for discharging gas may be located around the terminal portion.

The safety vent may be located below the cap up. The safety vent may include a protrusion that protrudes convexly downward and is connected to the subplate, and at least one notch located around the protrusion.

When gas is generated due to overcharging or abnormal operation of the secondary battery, the protrusion may be deformed upward by pressure and may separate from the subplate, while the safety vent may be cut along the notch. The cut safety vent may hinder or prevent the secondary battery from exploding by discharging gas to the outside.

The cap down may be located below the safety vent. The cap down may be formed with a first opening for exposing the protrusion of the safety vent and a second opening for discharging gas. The insulating member may be located between the safety vent and the cap down to insulate the safety vent and the cap down.

The subplate may be located below the cap down. The subplate may be fixed to a lower surface of the cap down to block the first opening of the cap down, and the protrusion of the safety vent may be fixed to the subplate. The first lead tab 35 pulled out from the electrode assembly 30 may be fixed to the subplate. Accordingly, the cap up, the safety vent, the cap down, and the subplate may be electrically connected to the first electrode 33 of the electrode assembly 30.

The insulating plate 37 may be located below the beading portion 43 to be in contact with the electrode assembly 30, and may be provided with a tab opening for pulling out the first lead tab 35. The cap assembly 50, which is electrically connected to the first electrode 33 by the first lead tab 35, may face the electrode assembly 30 with the insulating plate 37 interposed therebetween, and may maintain an insulated state from the electrode assembly 30 by the insulating plate 37. On the other hand, another insulating plate 36 may be included for insulation between the electrode assembly 30 and the bottom portion 41 of the case.

In an electrode plate coating and drying process, when a general method of measuring the density of an electrode plate through a density meter at the rear of a drying furnace is used, the coated electrode plate is passed through a number of heated drying areas (zones), the density of the electrode plate is measured through the density meter at the rear of the drying furnace, and the dry status of the electrode plate may be checked to make a pass/fail determination. When a fail determination has been made (e.g., non-dry/overdry), a process of allowing a re-coated electrode plate to pass through drying furnaces at a changed drying temperature, sending the re-coated electrode plate to the density meter, checking the drying status of the re-coated electrode plate, and optimizing drying conditions may be repeated.

According to such an example method, the drying status may not be monitored before the electrode plate reaches the density meter, and it may be difficult to reflect, in a drying recipe, the difference in suitable drying heat amount conditions varying depending on the thickness and composition ratio of the electrode plate. As a result, loss of electrode plates may occur during the process of repeating the electrode plate drying status check procedure and optimizing a drying condition. In addition, since drying furnace process conditions may be affected by seasonal temperature environments, quality problems for non-dried or over-dried products may be caused by environmental influences, even when the drying is performed under the same or similar process conditions. As an increase in the capacity of a secondary battery is required over time, changes occur in film thickening and active material composition ratio, making it more difficult to optimize temperature/heat amount control conditions for electrode plate drying after electrode plate coating.

In order to address the above challenges, examples of the present disclosure include a system and control method for monitoring the drying status of an electrode plate for each drying furnace area, and providing feedback to a drying furnace controller to control the temperature of the drying furnace in real time, thereby reducing or minimizing the time required for optimizing a drying process for each model of electrode plate and reducing loss of the electrode plate.

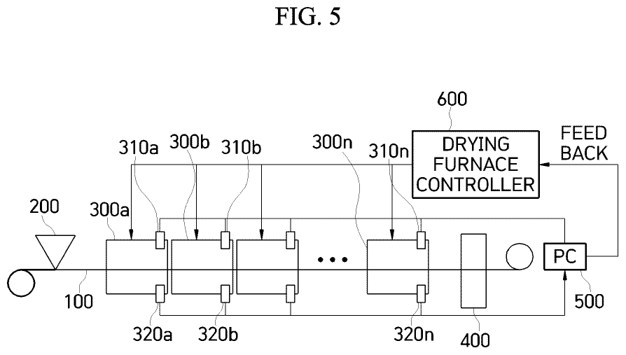

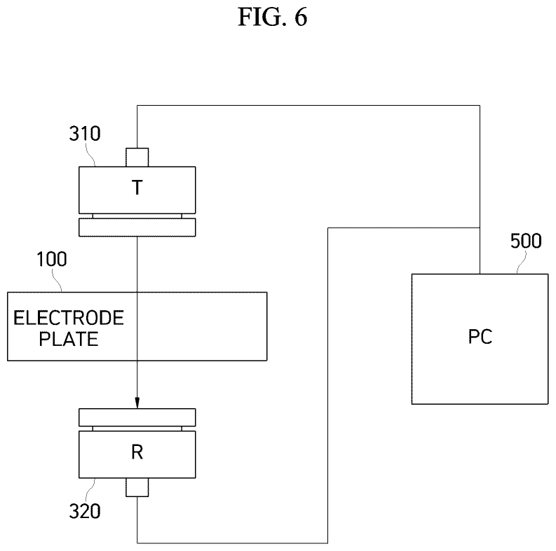

FIG. 5 illustrates a drying control system based on electrode plate drying status monitoring, according to an example embodiment of the present disclosure, and FIG. 6 illustrates a configuration an of ultrasonic transmitter/receiver and a PC, according to an example embodiment of the present disclosure.

In FIG. 5, an electrode plate 100 having passed through a coater 200 passes through drying furnaces 300a, 300b, . . . , 300n arranged for each drying area, and is subjected to a pass/fail determination through electrode plate density measurement using a density meter 400 located at the rear of the drying furnace. Before reaching the density meter, ultrasonic sensors (including ultrasonic transmitters 310a, 310b, . . . , 310n and ultrasonic receivers 320a, 320b, 320n) may monitor the drying status of the electrode plate, and disposed for each drying furnace.

Like light, ultrasonic waves can be transmitted, reflected, refracted, and integrated, and the aspect of a transmitted signal varies depending on the density of a medium. When ultrasonic waves pass through a medium, the higher the density of the medium, the stronger the signal transmission. The lower the density of the medium, the weaker the signal transmission, and the reflectivity and transmittance differ depending on the medium. Using such ultrasonic characteristics, the difference in density depending on a drying status is sensed during an electrode plate drying process, and the drying status of an electrode plate is monitored. The ultrasonic sensors include the ultrasonic transmitter 310a, 310b, . . . , 310n that generate ultrasonic waves and the ultrasonic receiver 320a, 320b, . . . , 320n that detect ultrasonic signals, and a PC 500 measures and displays the ultrasonic signals, provides a notification, and provides feedback to a drying furnace controller 600.

According to an example embodiment of the present disclosure, by monitoring the signal strength of ultrasonic waves measured differently according to the solvent residual amount of an electrode plate and changes in an internal density of the electrode plate due to evaporation, the drying status of the electrode plate may be determined for each drying furnace area in real time, and real-time control of the amount of drying heat required for each drying furnace area may be achieved, thereby allowing the electrode plate to be maintained in an optimal drying status when the electrode plate passes through all areas of the drying furnace, and reducing the lead time for determining the drying status of the electrode plate after electrode plate coating.

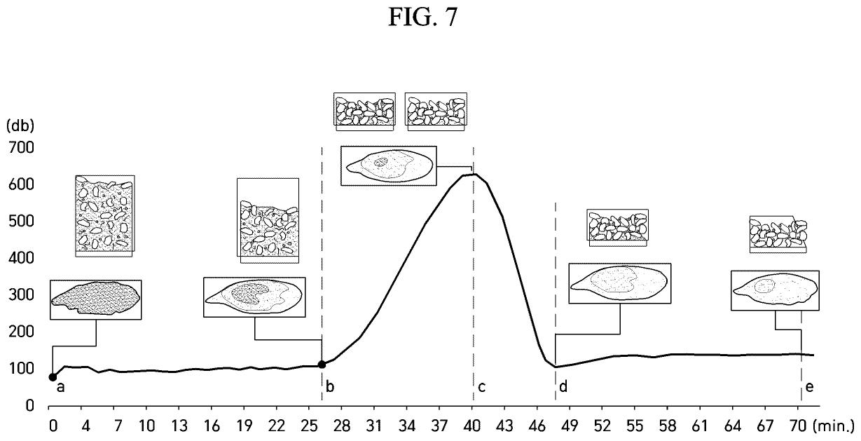

FIG. 7 illustrates an electrode plate drying status monitoring process, according to an example embodiment of the present disclosure. In FIG. 7, the x-axis represents time, and the y-axis represents the intensity of ultrasonic signal.

With reference to FIGS. 5 and 6, signals sensed by the ultrasonic sensors 310 and 320 are transmitted to the drying furnace controller 600 through the PC 500, and the drying furnace controller 600 uses feedback received from the PC 500 to control the amount of drying heat according to the drying status of the electrode plate at each drying stage.

In the process of drying the electrode plate, the solvent content on the surface and inside the active material of the electrode plate is changed, and the ultrasonic reflectivity and density of the active material on the surface of the electrode plate are changed. The drying status of the electrode plate is determined by monitoring changes in the density of the electrode plate through ultrasonic transmission and reception.

In an initial process of the electrode plate passing through the coater, a large amount of solvent may be present on the surface of the electrode plate, resulting in a high reflectance and low absorption rate for an ultrasonic signal generated from the ultrasonic transmitter 310, so that the intensity of an ultrasonic signal received from the ultrasonic receiver 320 is relatively low. When the ultrasonic sensor is disposed in an electrode plate surface solvent evaporation section (section a-b in FIG. 7 where the ultrasonic signal reflection by the electrode plate surface solvent is large and the ultrasonic transmission signal remains weak), as a large reflection signal above a preset standard is sensed by the surface solvent, the drying furnace controller 600 monitors whether the ultrasonic transmission signal is maintained below a certain standard.

During a drying process, typically, the solvent on the surface of the electrode plate evaporates, the electrode plate shrinks, and the thickness of the electrode plate decreases. As the ultrasonic absorption rate increases on the surface of the electrode plate due to the solvent evaporation and the density of the electrode plate increases caused by a decrease in the thickness of the electrode plate, the intensity of the ultrasonic signal received by the ultrasonic receiver rapidly increases. When the ultrasonic sensor is disposed in the electrode plate shrinkage section (section b-c in FIG. 7 where the electrode plate shrinks after the electrode plate surface solvent evaporation, and the intensity of the ultrasonic transmission signal increases rapidly due to a decrease in the thickness of the electrode plate and an increase in the density of the electrode plate), the drying furnace controller 600 monitors whether the ultrasonic transmission signal increases above a preset slope due to a decrease in the thickness of the electrode plate.

As the solvent between the active material molecules inside the electrode plate evaporates in a state where the thickness of the electrode plate is no longer reduced, pores start to form inside and the density of the electrode plate decreases, thereby generating an inflection point where the transmission intensity of the ultrasonic signal also begins to decrease. When the ultrasonic sensor is disposed in the solvent evaporation section within electrode plate pores (c-d section in FIG. 7 where the density decreases due to the formation of pores within the electrode plate and the intensity of the ultrasonic transmission signal rapidly decreases), the drying furnace controller 600 monitors whether the ultrasonic transmission signal is reduced above the preset slope due to a decrease in density caused by an increase in the formation of the electrode plate pores.

When all the solvent inside the electrode plate evaporates and the pores are substantially completely emptied, the time point, at which the density of the electrode plate remains substantially constant, the intensity of the ultrasonic reception signal remains substantially constant, and the ultrasonic reception signal remains substantially constant, is determined as a drying completion point. When the ultrasonic sensor is disposed in the electrode plate drying completion section (section d-e in FIG. 7 where no further solvent evaporation occurs, there is substantially no density change, and the intensity of the ultrasonic transmission signal is maintained below the preset standard), the drying furnace controller 600 monitors whether the density change is maintained within a preset or desired range.

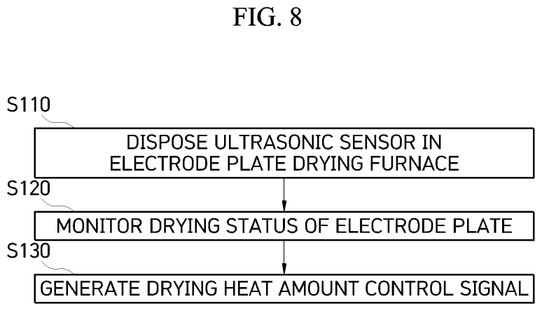

FIG. 8 illustrates a drying control method based on electrode plate drying status monitoring, according to an example embodiment of the present disclosure.

The drying control method based on electrode plate drying status monitoring, according to an example embodiment of the present disclosure, includes a step S110 of disposing the ultrasonic sensor in the electrode plate drying furnace, a step S120 of monitoring the drying status of the electrode plate, and a step S130 of generating an electrode plate drying heat amount control signal based on the monitoring results. Hereinafter, each step in FIG. 8 will be described in detail.

S110: Disposing ultrasonic sensor in electrode plate drying furnace

The ultrasonic sensors including ultrasonic transmitters and ultrasonic receivers are arranged in each drying furnace of a drying area.

The ultrasonic sensors are disposed in the electrode plate surface solvent evaporation section (e.g., the section where the ultrasonic signal reflection by the electrode plate surface solvent is large and the ultrasonic transmission signal remains weak), the electrode plate shrinkage section (e.g., the section where the electrode plate shrinks after the electrode plate surface solvent evaporation, and the intensity of the ultrasonic transmission signal increases rapidly due to a decrease in the thickness of the electrode plate and an increase in the density of the electrode plate), the solvent evaporation section within electrode plate pores (e.g., the section where the density decreases due to the formation of pores within the electrode plate and the intensity of the ultrasonic transmission signal rapidly decreases), and the electrode plate drying completion section (e.g., the section where no further solvent evaporation occurs, there is no density change, and the intensity of the ultrasonic transmission signal is maintained below the preset standard).

S120: Monitoring drying status of electrode plate

Because the ultrasonic reflectivity and active

material density of the electrode plate surface typically change during the electrode plate drying process in which the solvent content on the surface of the active material of and inside the electrode plate is changed, changes in the density of the electrode plate and the drying status of the electrode plate are monitored using the ultrasonic sensor. The drying status of the electrode plate having passed through the coater is monitored using the ultrasonic sensor disposed in each drying furnace area, and the PC receives signals sensed by the ultrasonic sensor and provides feedback to the drying furnace controller.

In the electrode plate surface solvent evaporation section, a large amount of solvent is typically present on the surface of the electrode plate, resulting in a high reflectance and low absorption rate for an ultrasonic signal generated from the ultrasonic transmitter, so that the intensity of an ultrasonic signal received from the ultrasonic receiver is relatively low. In this section, monitoring may be performed to determine whether the ultrasonic transmission signal is maintained below the given standard by the solvent on the surface of the electrode plate.

In the electrode plate shrinkage section, the solvent on the surface of the electrode plate typically evaporates, the electrode plate shrinks, and the thickness of the electrode plate decreases. As the ultrasonic absorption rate increases on the surface of the electrode plate due to the solvent evaporation, and the density of the electrode plate increases caused by a decrease in the thickness of the electrode plate, the intensity of the ultrasonic signal received by the ultrasonic receiver rapidly increases. In this section, monitoring may be performed to determine whether the ultrasonic transmission signal increases above the preset slope due to a decrease in the thickness of the electrode plate.

In the solvent evaporation section within the electrode plate pores, as the solvent between the active material molecules inside the electrode plate typically evaporates in a state where the thickness of the electrode plate is no longer reduced, pores may start to form inside, the density of the electrode plate may decrease, and the transmission intensity of the ultrasonic signal may also start to decrease. In this section, monitoring is performed to determine whether the ultrasonic transmission signal is reduced above the preset slope due to a decrease in density caused by an increase in the formation of the electrode plate pores.

In the electrode plate drying completion section, when substantially all of the solvent inside the electrode plate evaporates and the pores are substantially emptied, the density of the electrode plate remains substantially constant and the intensity of the ultrasonic reception signal remains substantially constant. In this section, monitoring is performed to determine whether the density change is maintained within the preset range.

S130: Generating electrode plate drying heat amount control signal

Ultrasonic signals are measured and displayed, notifications are provided, and feedback is provided to the drying furnace controller. Referring to the feedback, the drying status of the electrode plate for each drying furnace area is checked in real-time, and the amount of drying heat required for each drying furnace area is controlled in real-time.

According to another example embodiment of the present disclosure, before performing monitoring and drying control, learning about changes in ultrasonic transmission signals according to changes in density of the electrode plate is performed. In step S130, a command for the amount of drying heat is preset based on the results monitored in step S120 (e.g., a command related to the amount of drying heat is set/maintained by checking whether previously learned changes in the ultrasonic transmission signal are being followed), and the amount of drying heat is controlled. When the trend of changes in the ultrasonic transmission signal monitored in step S120 is different by more than a standard value compared to the previously learned changes in the ultrasonic transmission signal, step S130 uses the monitoring result to control the amount of drying heat according to the drying status of the electrode plate at each drying stage.

According to another example embodiment of the present disclosure, when the difference in the amount of change in the ultrasonic transmission signal over time monitored in step S120 is greater than a standard or desired value, it is determined that changes in the ultrasonic transmission signal do not follow the previously learned changes in the ultrasonic transmission signal due to environmental factors, etc., and a control command for changing the setting of the amount of drying heat may be generated. At this time, the hourly change in the amount of drying heat may be readily controlled to be above a preset value, or controlled to be below the preset value, or control may be performed to change the amount of drying heat during a preset or desired time interval.

According to another example embodiment of the present disclosure, when performing control to change the amount of drying heat, a temporal factor (e.g., specific drying heat amount maintenance time), a numerical factor of amount of drying heat (e.g., specific drying heat amount value), and a factor related to the amount of change in a drying heat amount for each drying area (e.g., value of change in the amount of drying heat set relatively for each adjacent drying area) can be adjusted, and it is possible to finally control changes in the setting of the amount of drying heat by adjusting a weight for each factor.

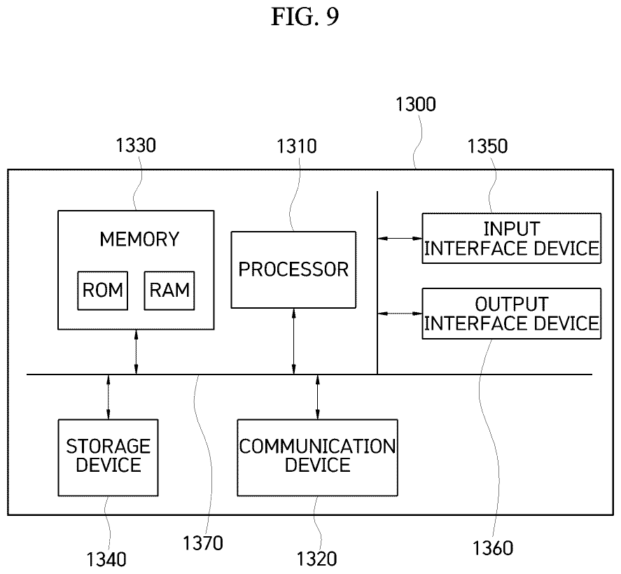

FIG. 9 is a block diagram illustrating a computer system for implementing a method according to an example embodiment of the present disclosure.

Referring to FIG. 9, the computer system 1300 may include at least one of a processor 1310, a memory 1330, an input interface device 1350, an output interface device 1360, and a storage device 1340 communicating with one another through a bus 1370. The computer system 1300 may also include a communication device 1320 coupled to a network. The processor 1310 may be or include a central processing unit (CPU) or a semiconductor device that executes instructions stored in the memory 1330 or in the storage device 1340. The memory 1330 and the storage device 1340 may include various types of volatile or nonvolatile storage media. For example, the memory may include a read-only memory (ROM) and a random access memory (RAM). In example embodiments of the present disclosure, the memory may be located inside or outside the processor, and may be connected to the processor through various known means. The memory is or includes various types of volatile or nonvolatile storage media, and for example, may include a read-only memory (ROM) or a random access memory (RAM).

Accordingly, example embodiments of the present disclosure may be implemented as a method implemented in a computer or a non-transitory computer-readable medium storing computer-executable instructions. In an example embodiment, when executed by the processor, computer-readable instructions may perform a method according to at least one aspect of the present disclosure.

The communication device 1320 may transmit or receive wired signals or wireless signals.

Additionally, the method according to an example embodiment of the present disclosure may be implemented in the form of program instructions that can be executed through various computer means and recorded on a computer-readable medium.

The computer-readable medium may include program instructions, data files, data structures, etc., singly or in combination. The program instructions recorded on the computer-readable medium may be specially designed and configured for the example embodiments of the present disclosure, or may be known and usable by those skilled in the art of computer software. Computer-readable recording media may include a hardware device configured to store and perform program instructions. For example, the computer-readable recording media may be or include magnetic media such as hard disks, floppy disks, and magnetic tapes, optical media such as CD-ROMs and DVDs, magneto-optical media such as floptical disks, ROM, RAM, flash memory, etc. The program instructions may include not only machine language codes such as that generated by a compiler, but also high-level language codes that can be executed by a computer through an interpreter, etc.

Hereinafter, any material that may be usable for the secondary battery according to examples of the present disclosure will be described.

As the positive electrode active material, a compound capable of reversibly intercalating/deintercalating lithium (e.g., a lithiated intercalation compound) may be used. For example, at least one of a composite oxide of lithium and a metal such as at least one of cobalt, manganese, nickel, and combinations thereof may be used.

The composite oxide may be or include a lithium transition metal composite oxide, and examples thereof may include at least one of a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by at least any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}GbO₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5) ; Li_{(3-f)}Fe₂ (PO₄)₃ (0≤f≤2 ); and LiₐFePO₄ (0.90≤a≤1.8).

In the above formulas: A is or includes at least Ni, Co, Mn, or a combination thereof; X is or includes at least Al, Ni, Co, Mn, Cr, Fe, Mg, Sr, V, a rare earth element, or a combination thereof; D is or includes at least O, F, S, P, or a combination thereof; G is or includes at least Al, Cr, Mn, Fe, Mg, La, Ce, Sr, V, or a combination thereof; and L1 is or includes at least Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be or include aluminum (Al) but is not limited thereto.

The negative electrode active material may include

a material capable of reversibly intercalating/deintercalating at least one of lithium ions, lithium metal, an alloy of lithium metal, a material capable of being doped and undoped with lithium, or a transition metal oxide.

The material capable of reversibly intercalating/deintercalating lithium ions may be or include a carbon-based negative electrode active material, which may include, for example, at least crystalline carbon, amorphous carbon, or a combination thereof. Examples of the crystalline carbon may include graphite, such as natural graphite or artificial graphite, and examples of the amorphous carbon may include at least one of soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be or include at least silicon, a silicon-carbon composite, Sioₓ (0<x<2), a Si-based alloy, or a combination thereof.

The silicon-carbon composite may be or include a composite of silicon and amorphous carbon. According to one example embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, at least one of copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent may constitute a medium through which ions involved in the electrochemical reaction of the battery can move.

The non-aqueous organic solvent may be or include at least a carbonate-based, an ester-based, an ether-based, a ketone-based, an alcohol-based solvent, an aprotic solvent, and may be used alone or in combination of two or more.

Depending on the type of lithium secondary battery, a separator may be present between the first electrode plate (e.g., the negative electrode) and the second electrode plate (e.g., the positive electrode). As the separator, at least polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth) acrylic polymer.

The inorganic material may include inorganic particles such as at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg (OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

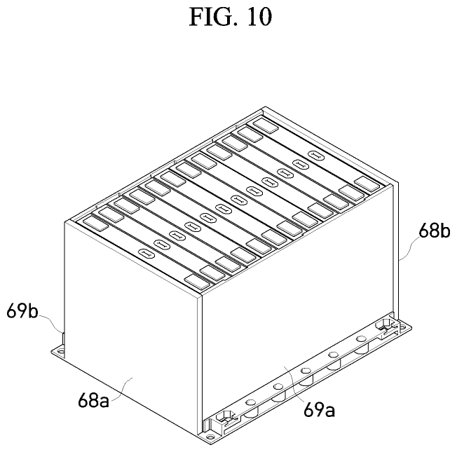

FIG. 10 is an illustration of a secondary battery module in which secondary batteries manufactured according to examples of the present disclosure are arranged. With the increase in secondary battery capacity for driving electric vehicles, and the like, a secondary battery module may be manufactured by arranging and connecting a plurality of secondary battery cells transversely and/or longitudinally. The plurality of secondary batteries may be arranged in a space defined by a pair of facing end plates 68a and 68b and a pair of facing side plates 69a and 69b. The secondary batteries may be designed appropriately in arrangement (direction) and number to obtain desired voltage and current specifications.

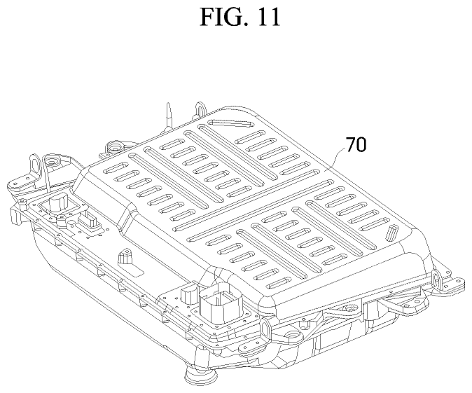

FIG. 11 is an illustration schematically showing the configuration of a battery pack 70 according to example embodiments of the present disclosure. Referring to FIG. 10, a battery pack 70 may include an assembly to which individual batteries are electrically connected, and a pack housing accommodating the same. In the drawings, for convenience of illustration, components including a bus bar, a cooling unit, external terminals for electrically connecting batteries, etc., are not shown.

The battery pack 70 may be mounted on (or in) a

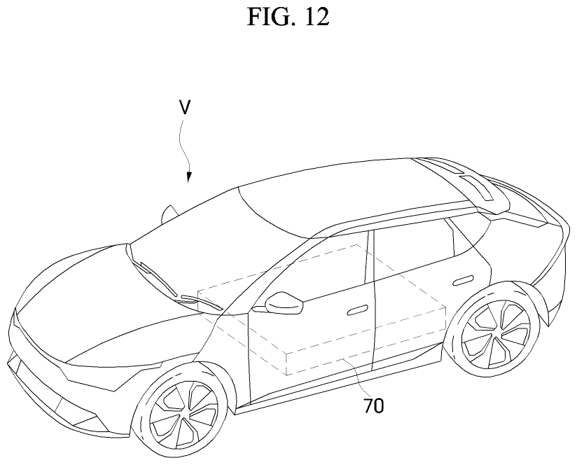

vehicle. The vehicle may be, for example, an electric vehicle, a hybrid vehicle, a plug-in hybrid vehicle, and the like. The vehicle may be a four-wheeled vehicle or a two-wheeled vehicle but is not limited thereto. FIG. 12 shows a vehicle V which includes the battery pack 70 shown in FIG. 11 on the lower body thereof. The vehicle V may operate by (e.g., may be powered by) receiving power from the battery pack 70.

According to examples of the present disclosure, considering that the typically high investment cost per unit of a density meter makes it relatively costly when installed in various areas of a drying furnace, and installation thereof inside the drying furnace is difficult in terms of size, a difference in an ultrasonic transmission state due to a density difference depending on the drying status of an electrode plate may be monitored through an ultrasonic sensor, and the amount of drying heat inside the drying furnace may be controlled in real-time based on the monitoring results. Accordingly, when an electrode plate composition or a loading level is changed after a job change, or the surrounding air temperature is changed due to seasonal effects, and the like, it is possible to greatly reduce the trials and errors in a process of optimizing electrode plate drying conditions at the beginning of a process, minimize loss of the electrode plate, and improve the productivity of drying furnace equipment and the overall efficiency of an electrode plate drying process.

However, effects that can be achieved through the present disclosure are not limited to the above-described effects, and other technical effects not mentioned will be clearly understood by those skilled in the art from the description of the invention described below.

Although the present disclosure has been described

above with respect to example embodiments thereof, the present disclosure is not limited thereto. Various modifications and variations can be made thereto by those skilled in the art within the spirit of the present disclosure and the equivalent scope of the appended claims.

What is claimed is:

1. A drying control system based on electrode plate drying status monitoring, the drying control system comprising:
an ultrasonic sensor located in a preset area of a secondary battery electrode plate drying furnace; and
a drying furnace controller configured to monitor a drying state of an electrode plate using a signal acquired from the ultrasonic sensor, and to generate and transmit a drying heat amount control signal according to a result of the monitoring.

2. The drying control system according to claim 1, wherein the ultrasonic sensor is located in the preset area of at least one of an electrode plate surface solvent evaporation section, an electrode plate shrinkage section, a solvent evaporation section within electrode plate pores, and an electrode plate drying completion section.

3. The drying control system according to claim 1, wherein the drying furnace controller is configured to monitor whether an ultrasonic transmission signal is maintained below a certain standard when the ultrasonic sensor is in the electrode plate surface solvent evaporation section and a reflection signal above a preset standard is sensed by a surface solvent.

4. The drying control system according to claim 1, wherein the drying furnace controller is configured to monitor whether an ultrasonic transmission signal increases above a preset slope due to a decrease in a thickness of the electrode plate when the ultrasonic sensor is disposed in the electrode plate shrinkage section.

5. The drying control system according to claim 1, wherein the drying furnace controller is configured to monitor whether an ultrasonic transmission signal is reduced above a preset slope due to a decrease in density caused by an increase in a formation of electrode plate pores when the ultrasonic sensor is disposed in the solvent evaporation section within electrode plate pores.

6. The drying control system according to claim 1, wherein the drying furnace controller is configured to monitor whether a density change is maintained within a preset range when the ultrasonic sensor is disposed in the electrode plate drying completion section.

7. A drying control method based on electrode plate drying status monitoring performed by a drying control system based on electrode plate drying status monitoring, the drying control method comprising:
(a) disposing an ultrasonic sensor in an electrode plate drying furnace; and
(b) monitoring a drying status of an electrode plate by using ultrasonic at least one of transmission and reception information acquired using the ultrasonic sensor.

8. The drying control method according to claim 7, wherein disposing the ultrasonic sensor in the electrode plate drying furnace comprises disposing the ultrasonic sensor in at least one of an electrode plate surface solvent evaporation section, an electrode plate shrinkage section, a solvent evaporation section within electrode plate pores, and an electrode plate drying completion section.

9. The drying control method according to claim 8, wherein, when the ultrasonic sensor is disposed in the electrode plate surface solvent evaporation section, monitoring the drying status of the electrode plate comprises monitoring whether an intensity of an ultrasonic transmission signal is maintained below a certain standard as a surface solvent causes ultrasonic reflection above a preset standard.

10. The drying control method according to claim 8, wherein, when the ultrasonic sensor is disposed in the electrode plate shrinkage section, monitoring the drying status of the electrode plate comprises monitoring whether an intensity of an ultrasonic transmission signal increases above a preset slope as a thickness of the electrode plate decreases.

11. The drying control method according to claim 8, wherein, when the ultrasonic sensor is disposed in the solvent evaporation section within electrode plate pores, monitoring the drying status of the electrode plate comprises monitoring whether an intensity of an ultrasonic transmission signal is reduced above a preset slope due to a decrease in density caused by an increase in a formation of electrode plate pores.

12. The drying control method according to claim 8, wherein, when the ultrasonic sensor is disposed in the electrode plate drying completion section, monitoring the drying status of the electrode plate comprises monitoring whether an intensity of an ultrasonic transmission signal is maintained within a preset range.

13. The drying control method according to claim 7, further comprising:
(c) generating an electrode plate drying heat amount control signal based on a result of the monitoring.
